(19) United States
(12) Patent Application Publication
(10) Pub. No.: US 2014/0081679 A1
(43) Pub. Date: Mar. 20, 2014

(54) Release Management System and Method

(71) Applicants: Michael Volkmer, Heidelberg (DE); Dietmar Reinwald, Neckargerach (DE)

(72) Inventors: Michael Volkmer, Heidelberg (DE); Dietmar Reinwald, Neckargerach (DE)

(73) Assignee: SAP AG, Walldorf (DE)

(21) Appl. No.: 13/622,291

(22) Filed: Sep. 18, 2012

(51) Int. Cl. G06Q 10/00

(52) U.S. Cl. 705/7.11

(57) ABSTRACT

A method includes obtaining an existing process structure for multiple life cycle stages of a process lifecycle instance, using a release version matrix to represent the process structures, receiving a release change indication, copying the existing process structures into new release process structures to represent a new version of the process in response to the release change, and updating the release version matrix to identify the new version of the process structures.

### BACKGROUND

Businesses today use enterprise software systems to realize many aspects of the business, such as everyday operations, controlling, reporting, human resource management to name a few. Every activity of the business may be modeled in the system. Employees perform tasks utilizing the system. Enterprise software systems may be implemented in an information technology landscape of a business within complex projects, usually over the course of months or years. Requirements of a business activity to be realized may be collected prior to developing code in the form of objects.

Projects may have several different lifecycle stages, including for example a design phase, an implementation phase, upgrades, maintenance, and others. In each of these stages, objects that build the system are copied from one stage to the next, and are modified in the next stage according to requirements of the system. As objects are modified in different projects stages, the objects are tracked, and content compared from different project stages.

A solution manager unified directory (SMUD) provides a platform to manage business processes that are supported by SAP solutions, including ERP, CRM, and others. The processes are designed based on business requirements as described above, and a lifecycle includes implementing processes in software objects, at least partially via customization of a library of objects. The objects may be tested, and deployed into a production, where they are used to perform tasks in support of the business objectives. During this lifecycle, different versions of a process are managed so that design versions may be changed without impacting production versions. SMUD also provides the ability to track the objects and compare objects between different lifecycle stages.

### SUMMARY

A method includes obtaining an existing process structure for multiple life cycle stages of a process lifecycle instance, using a release version matrix to represent the process structures, receiving a release change indication, copying the existing process structures into new release process structures to represent a new version of the process in response to the release change, and updating the release version matrix to identify the new version of the process structures. The method is performed by a programmed computer system via a computer readable storage device in one embodiment.

A computing system includes an object repository to maintain a set of objects. A project stage module maintains an object in each of a set of project stages. A matrix builder module build a release version matrix for the object when the object transitions from a source object in a first release to a target object in a second release, wherein the release version matrix includes a first column to represent the first release, a second column to represent the second release, and a row to represent a predecessor object. A row may also be included for an archive version of the object. A memory may be provided to store the release version matrix of the object.

### BRIEF DESCRIPTION OF THE DRAWINGS

FIG. 1 is a table illustrating a release sequence according to an example embodiment.

FIG. 2 is a table illustrating two releases of a release sequence and their logical components respectively according to an example embodiment.

FIG. 3 is a table illustrating a minor release sequence according to an example embodiment.

FIG. 4 is a block flow diagram illustrating a release sequence in a lifecycle instance during a release change according to an example embodiment.

FIG. 5 is a block flow diagram illustrating a release origin matrix for a release sequence according to an example embodiment.

FIG. 6 is a block flow diagram illustrating utilization of a release sequence in a lifecycle instance and release transition according to an example embodiment.

FIG. 7 is a block flow diagram illustrating a situation following release transition according to an example embodiment.

FIG. 8 is a block flow diagram illustrating document matrices for multiple life cycle stages according to an example embodiment.

FIG. 9 is a block flow diagram illustrating document matrices for a changed document according to an example embodiment.

FIG. 10 is block diagram illustrating components of a programmed computer for managing different releases according to an example embodiment.

FIG. 11 is a block diagram illustrating a specifically programmed computer for executing version management according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In a new release, release versions of the processes are maintained by the software management system so that it is possible to manage different version of a process in one release (e. g. a design, build, and production version) and a separate new release version of the same process that describe how the process shall run in a new release. In such a situation, the lifecycle of the process versions is managed so that it is for example possible to bring changes that are maintained for the old release version and are also relevant for the new release in a consistent way from one release to another. The different process releases are triggered by changes to the underlying system landscape (e. g. a new release or enhancement package is applied to the landscape).

In addition, the software management system provides the ability to distinguish how new releases for the process structure are managed so that it is possible to define releases, provide the release version and consume them.

A release definition (release sequence with releases related to the system landscapes) is provided that can be used to define process structure releases as SMUD instances (SMUDIs). The well-known concept of the origin matrix is enhanced to store predecessor release data that allows to manage (compare, adjust, merge) versions across different releases. The management and application of releases is done via Release Changes and Release Transitions that allow defining new process structure releases and bringing them consistently into productions. This is baaed on a lifecycle management model and a release transition algorithm.

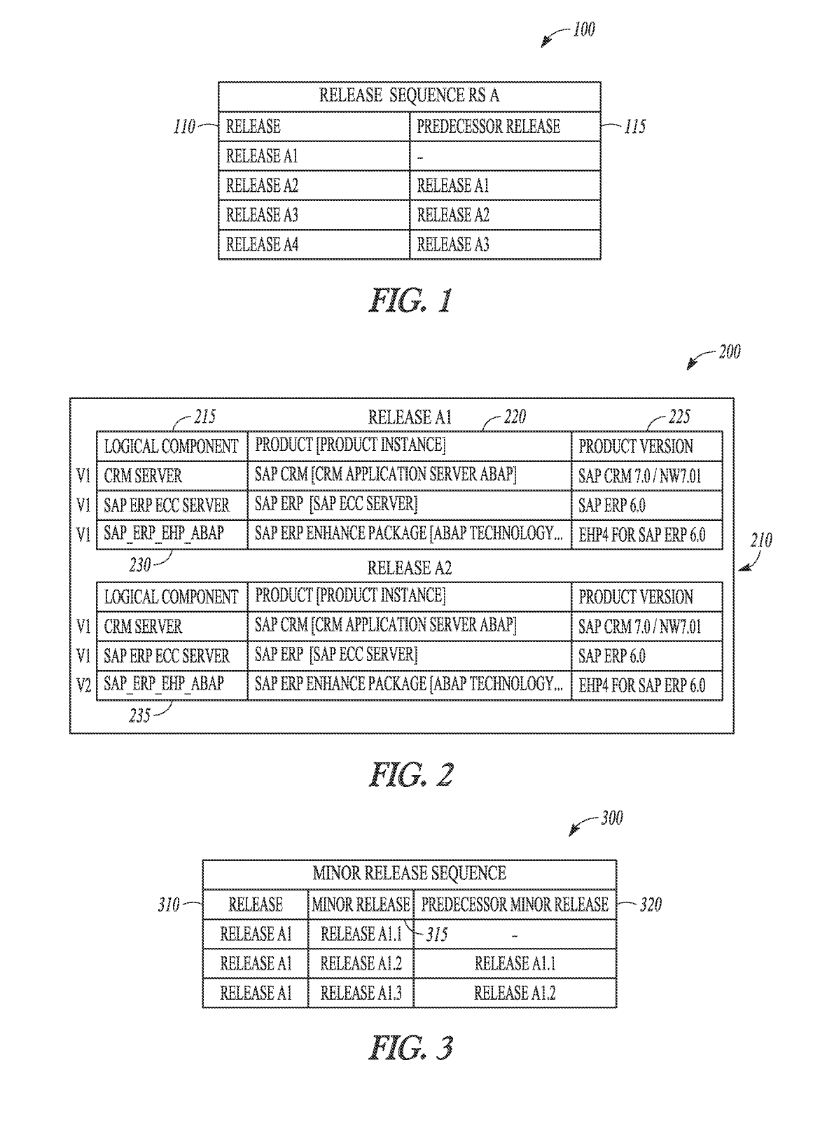

A new software release represents a major change of a business management system landscape. This might be caused by the implementation of a new release or enhancement package provided by the software vendor such as SAP or by major customer developments. The lifecycle of a new release can be described in the same way as the lifecycle of the old release. Since a new release is usually seen as successor of an existing release, a release sequence may be defined that describes the relations between different releases as illustrated in a table in FIG. 1 at 100 showing a column of the releases 110 and a column for predecessor releases 115.

Thus, a release sequence consists of a list of releases, A1, A2, A3, and A4 that represent a linear order of the releases. Release A1 has no predecessor release. Release A2 has a predecessor of A1, A3 has a predecessor of A2, and release A4 has a predecessor of A3. Since a release represents a major change in the software and the software is represented via logical components in the process structure, logical component versions can be used to describe the major change in a release management portion of a software management system such as SAP ERP. The release change is done in the managed system which is usually an ERP, SAP, CRM, or other system. In Solution Manager, the process structures that describe the managed software are maintained via SMUDIs. In various embodiments, change and version management functions may be enhanced so that different versions of process structure elements can be managed across different releases and provide for management of several releases in parallel. Existing lifecycle and version management functionality may be used for different releases and different versions of process structures and assignments within one release in parallel.

FIG. 2 is a table illustrating components of two releases, release A1 at 200 and release A2 at 210. A logical component column 214 lists logical components in both releases. A product column 220 lists product instances in each release. A product version column 225 lists product version information. Both releases contour a first version of both CRM Server and SAP ERP ECC Server. Release A1 200 contains logical component version 1 of SAP_ERP_EHP_ABAB at 230, whereas release A2 210 contains logical component version 2 of SAP_ERP_EHP_ABAB at 235.

Two releases of the same release sequence do not need to differ in their logical component versions due to customer developments. Nevertheless, to document the changes in the landscape, it would make sense to define two different logical component versions that are based on the same product version.

FIG. 3 illustrates a minor release sequence at 300. A release may consist of minor releases that are used to organize maintenance within the releases. A release column 310 lists the main releases, A1, A1, and A1 in this example. A minor release column 315 illustrates a sequence of minor releases A1.1, A1.2, and A1.3, with a predecessor minor release column 320 listing the corresponding predecessor minor releases A1.1 and A1.2 for minor release A1.2 and A1.3 respectively.

Minor releases are not explicitly used within SMUD. They are used together with Change Request Management (ChaRM) so that changes during a minor release can be recorded via a change request. A change request can be associated with a “check-out”.

Implementation projects, upgrade projects and solutions are associated with exactly one release. Since they consume releases that are provided to them (Release Consumer). An implementation project implements one release. An upgrade project manages the upgrade from a lower to a higher release. The upgrade project is associated with the target release. A solution reflects the productive usage of one release. New releases are created usually based on templates or a CPD (customer process directory). They define releases and provide them to consumers (Release Provider).

A new release is defined within its release sequence. New release-based object versions are usually created in the “Design Environments” (template, CPD). A new release is rolled-out via an upgrade project that is defined based on a solution of the predecessor release. Maintenance of changes within a release and upgrades to new releases may be done in parallel. Compare & adjust functionality is needed to manages parallel changes.

The release management functionality can be activated for a lifecycle instance. This is done by assigning a release sequence to the lifecycle instance. If this functionality is selected, for each SMUD instance (SMUDI), such as CPD instance, project instance, solution instance, etc., of the lifecycle instance it can be decided whether it is a provider or a consumer of a release. This selection is used, to provide the necessary provider/consumer functionality for the SMUDI.

The assignment of a release to a SMUDI can also be used to determine the system landscape for the corresponding SMUDI (list of logical component versions as illustrated in FIG. 2).

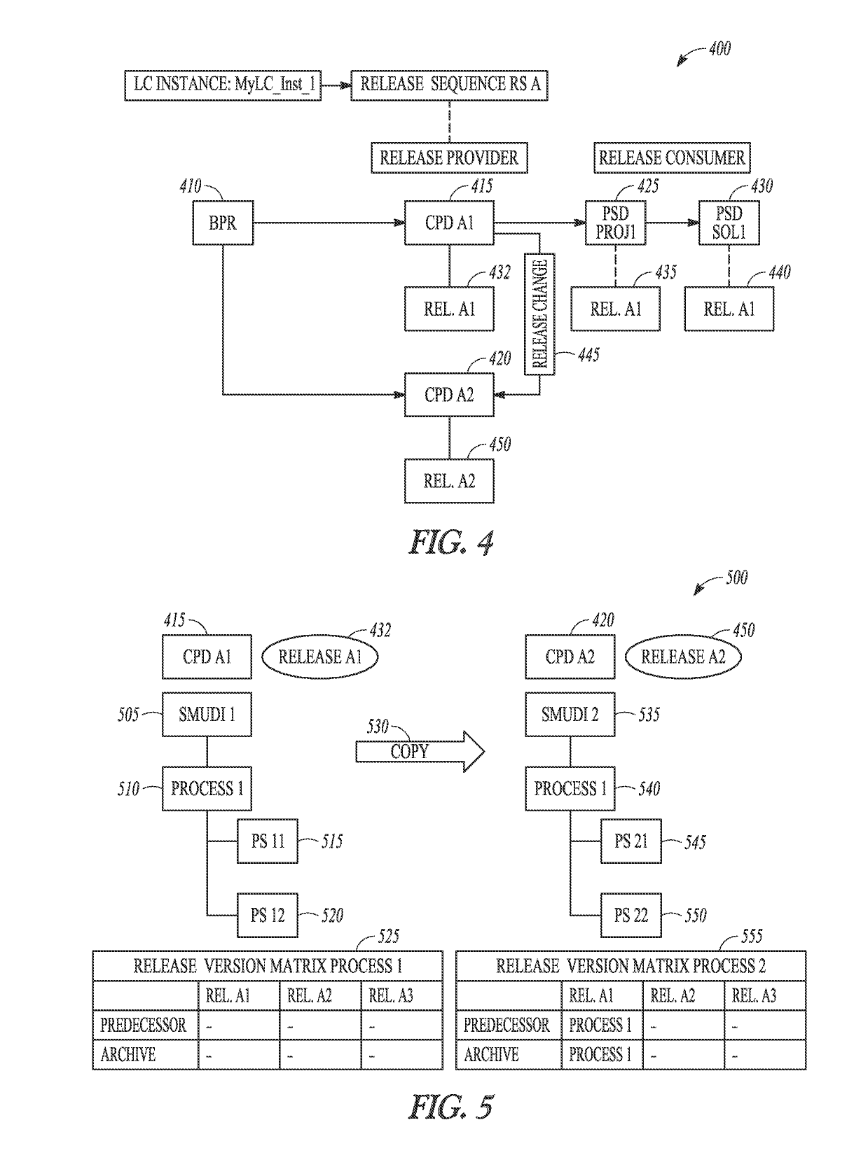

In one example in FIG. 4, a block flow diagram of utilization of a release sequence in a lifecycle instance of MyLC_Inst_1 that is associated with release sequence RS A, illustrating release changes is shown generally at 400. A business process repository (BPR) 410 is shown and leads to a CPD which is a release provider in which release versions of the process structure can be managed (version CPD A1 415 and CPD A2 420). The release provider helps to manage the definition and maintenance of new releases from a release process structures. Release consumers manage the consumption of a new release from a release provider based on a release sequence. The two PSD instances Proj1 425 and Sol1 430 are consumers of release A1 432 at 435 and 440 respectively. In one embodiment, changes in CPD A1 can be brought to Sol1 via a compare and adjust function. In parallel, a new version of CPD A1 is created, called CPD A2.

The creation of a new release based on a SMUDI (e. g. based on CPD A1) is called “Release Change” at 445. As a result a new SMUDI (e. g. CPD A2) at 420 is created with a corresponding release A2 at 450. A release change is a copy of the SMUDI of the predecessor release. The compare and adjust function supports change management between SMUDIs that belong to the same release sequence.

Input to a release change in one embodiment is a SMUDI that is associated with a release and a successor release of the common release sequence. Output is a “release successor” SMUDI that is associated with the successor release. Management of process versions that are based on a release is done in the same way as described for lifecycle versions via a release version matrix with predecessor and archive data as illustrated at 500 in an illustration of an example release origin matrix of FIG. 5. Thus, the existing version and lifecycle functionality can be used to manage the release versions of process structure elements.

In FIG. 5, CPD A1 415 and CPD A2 420 are shown in one example along with Release A1 432 and A2 450. An instance associated with CPD A1, SMUDI 1 is shown at 505. It references a Process 1 at 510, which contains two process steps PS11 at 515 and PS12 at 520. A matrix 525 for process 1 contains three columns, one for each of Release A1, Release A2, and Release A3 with rows for predecessor and archive references. This existing information for release A1 432 is copied as indicated at 530 into corresponding blocks SMUDI 2 at 535. Process 2 at 540, PS21 at 545, process PS22 at 550 and matrix for process 2 at 555. Matrix 555 contains similar columns, with the Release A1 column now containing references to Process 1 as both a predecessor release and an archive release. In further embodiments, the release origin matrix 500 may store each release as a row.

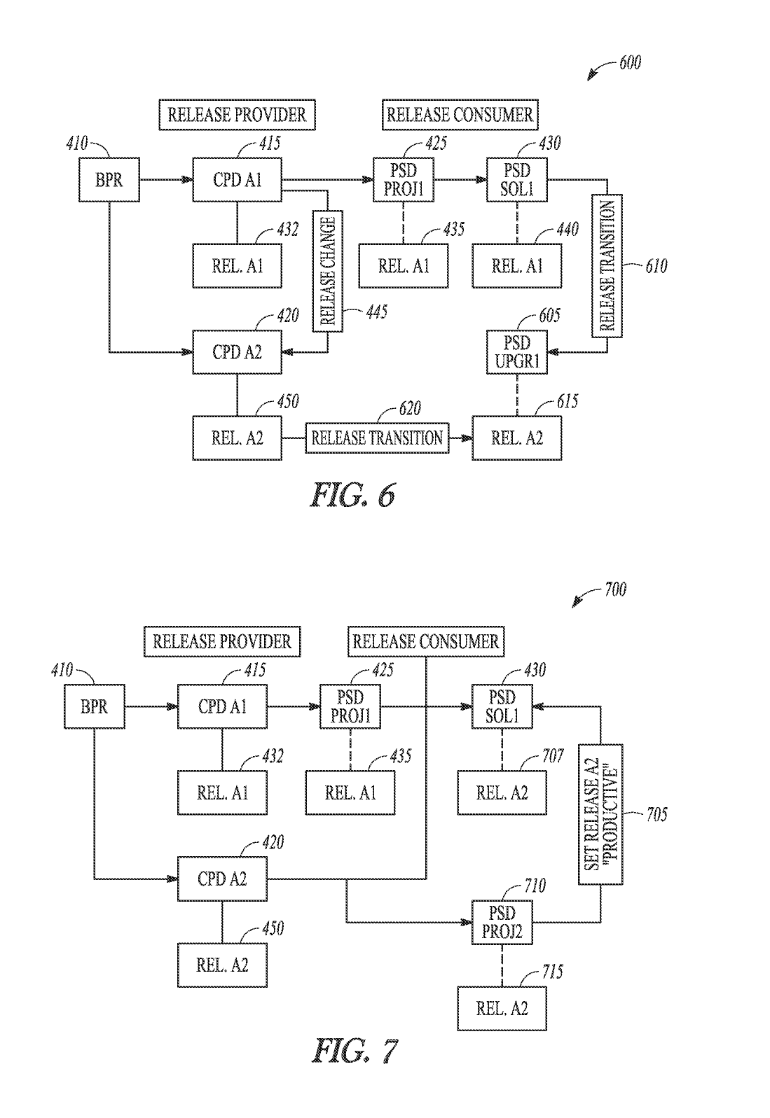

The rollout of a new release into a solution may be done based on an upgrade project. This process is called Release Transition 600 as illustrated in the block flow diagram of FIG. 6. The starting point of a release transition is the solution that is to be brought to a new release, from release A1 432 to release A2 450. Generally, objects concerned by the release transition are copied from a release provider, as may be identified by a user, to a release consumer as indicated in an upgrade (Upgr1) project 605 that is associated with the solution (Sol1) via release transition 610. This ensures that maintenance work can be done in parallel to the upgrade.

In detail, a release transition is performed as follows. A compare between the SMUDIs CPD A2 and Sol1 is done to find out, which part of the process structure in Sol1 is concerned by the new release. The concerned part is copied from Sol1 to the upgrade project Upgr1 as a starting point for the upgrade. A compare and adjust is made between CPD A2 and Upgr1 to bring Upgr1 to release A2. Since changes may have been applied to Sol1 in the meantime due to maintenance, compare & adjust is used to finally bring the SMUDI of Upgr1 into Sol1.

In further embodiments, the user or customer may specify that such transitions occur automatically, or may mark and decide interactively to manually manage changes. Target release of the upgrade project is the new release A2 at 615. Via compare and adjust against the “design” versions of the process structure in CDP A2 420, new process versions are defined in the upgrade project. As soon as the upgrade project is finished, the new process versions are brought into the solution. The process structure in the solution might have been changed in the time period of the upgrade project.

Compare and adjust is used to bring the new versions into the solution as shown at 700 in FIG. 7. This the final step in the release sequence illustrated for a lifecycle instance showing the situation after release transition. Compare and adjust is used to set release A2 to a productive stage as indicated at 705.

Resulting in a new release for PSD Sol1 at 707. PSD Proj2 at 710 illustrates an additional new project that implements new functionality based on release A2 at 715 that does not interfere with the already used functionality that may later be added to Sol1 430.

Non-process structure objects of a SMUDI are all objects that are associated with objects of the process structure, such as transactions, test cases, documents, etc. Objects that are located in a managed system will not take part in the described lifecycle and release management since they are only associated as an “external object link” to the process structure. Therefore, only the link, which is a link between a process occurrence and a proxy object—will take part.

Objects are located in Solution Manager that are not part of SMUD may take part in lifecycle and release management. In one embodiment documents are an example of object types of this kind. Changes of document attributes and the document itself are recorded in a history via the PHIO (document history versions) concepts. It may be customizable whether each change of a document causes the creation of a new PHIO or not or whether the user can decide to create a new history version.

Document versions may exist within a release. For each document occurrence it can be decided how it should be treated according to versions. No version may be created for general documentation. A version may be created according to its parent structure node (e. g. a process)

Thus, there may be a “design”, a “build” and a “productive” version of the same document within a release based on the corresponding versions of its structure object. Document versions may be based on a release sequence. If a structure object is brought to a new release, the corresponding documents are also brought (copied) to the new release.

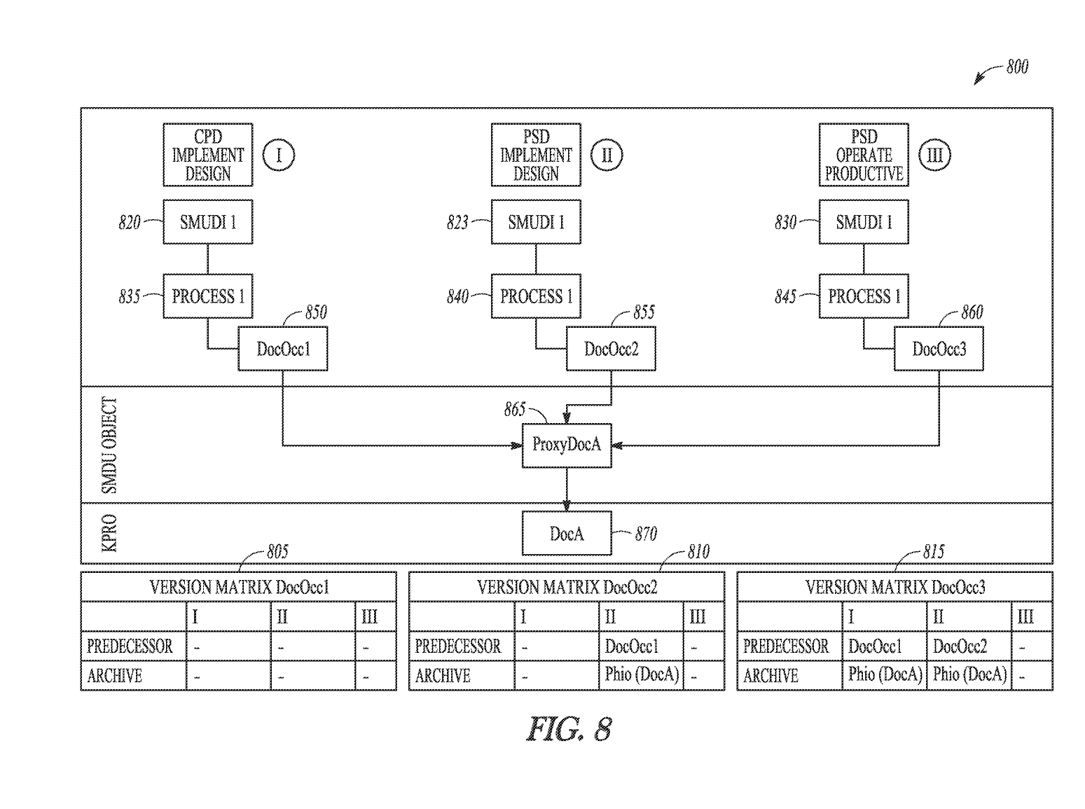

There may more options for document handling, such as changes to a document that is associated to more than one process occurrence within one SMUDI may be handled in a way so that all occurrence reference the same document version at all times. In general, the above described versions are the same as needed for the process structure. Therefore, a similar functionality of version handling for documents in SMUD is shown at 800 in FIG. 8.

Similar to the version matrix of a process structure element, a version matrix 805, 810, 815 for documents is provided that is based on the common lifecycle model. If a process element is copied from one SMUDI 820, 825, 830 to another in accordance with the lifecycle instance, corresponding process structure 835, 840, 845 and document version matrices 805, 810, 815 are created. Since documents are external SMUD objects, the handling is slightly different.

For each document assignment a document occurrence object 850, 855, 860 is available in SMUD. For each document occurrence a link to a SMUD (proxy) object 865 is available. Documents are linked to the corresponding SMUD proxy object. The document version itself might be done according to certain exception rules, like for “General Documentation” no versions shall be created. Always a link to an original document 870 is kept. If the same content is linked to several processes in the same SMUDI, the same document version should be linked.

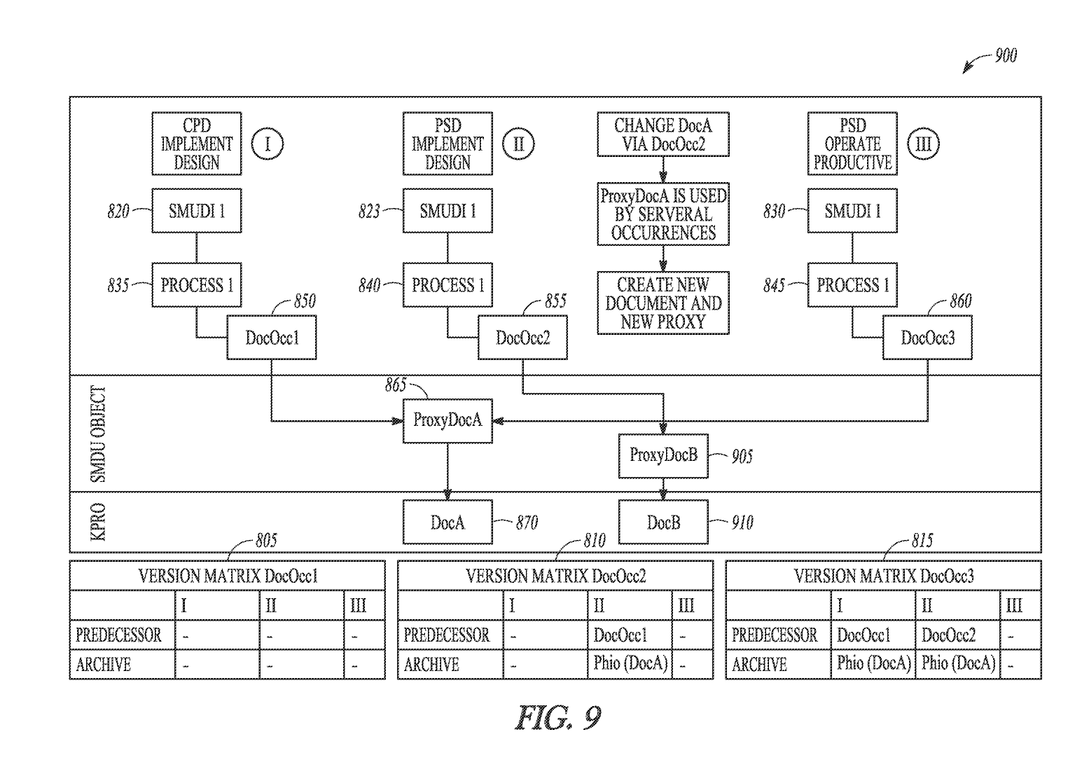

The normal versioning will work as follows. A document is changed through the assignment of a document to a process in a SMUDI document occurrence as illustrated at 900 in FIG. 9 DocOcc2 855.

If a document is changed, it is checked whether the corresponding proxy object is used by several document occurrences ProxyDocA 865 is used by three document occurrences in FIGS. 8 and 9. If no, the document is changed and a new PHIO is created.

If yes, a new proxy object ProxyDocB 905 and a new document DocOcc2 is created that is associated with the proxy object 905. DocB 910 is created as a copy of DocA 870. ProxyDocB is associated with DocOcc2 855. If an exception rule exists, this might cause additional adjustments. For example, if exception rule 2 from above is valid, it needs to be checked, if DocA is associated with other document occurrence in SMUDI 2. If this is the case, document occurrences need to change their link from ProxyDocA 865 to ProxyDocB 905.

The corresponding document version matrices 805, 810, and 815 still allow seeing that DocA is the “design” version and DocB the “build” version of the same document. DocB 910 is associated with DocOcc2 855 via ProxyDocB 905. Thus, version matrix DocOcc2 is associated with DocB. DocB will be part of a version matrix as an archive entry, as soon as its associated SMUD occurrence is copied. For DocA in DocOcc3 the following can now be derived from its version matrix. Its predecessor in SMUDI 2 (II) is DocB (via DocOcc2). The document version at the point in time of the copy of the corresponding process (copy from Process 2 to Process 3) is DocA (PHIO (DocA) in version matrix DocOcc3)

In various embodiments, the improved software management system can handle many different examples of release management. One example, assumes that a customer has created a template project that contains process structure elements from his current system landscape (e. g. a Customer Relationship Management (CRM 5.0) system and an Enterprise Resource Planning (ERP 6.0 EhP1) system. The template has been rolled-out to a subsidiary that makes an implementation project based on the template that leads to a productive usage of the processes in a so-called solution.

Now a new enhancement package (SAP ERP 6.0 EhP2) is planned where several business function are to be implemented that will have a major impact on the process structure. In this case, a process structure is to be established for the new system landscape that takes the existing process structure as a starting point. Since the process structure of the old landscape will be in productive use until it will be replaced by the new one, this process structure has to be separated from the new one so that it is possible to maintain changes (maintenance) for the old release and design the new process structure for the new release independently. On the other hand, it must be possible to bring changes that are applied to the old release and are also relevant to the new one, in an easy and consistent way to the new process structure.

A soon, as the design of the new process structures is finished (release provisioning) it should be brought into the solution so that it can replace the old solution (release consumption). This is supported in a way so that all changes that have been done in the old solution are merged with the new release version.

FIG. 11 is a block diagram of a computer system to implement methods according to an example embodiment. In the embodiment shown in FIG. 11, a hardware and operating environment is provided that is applicable to any of the servers and/or remote clients shown in the other Figures.

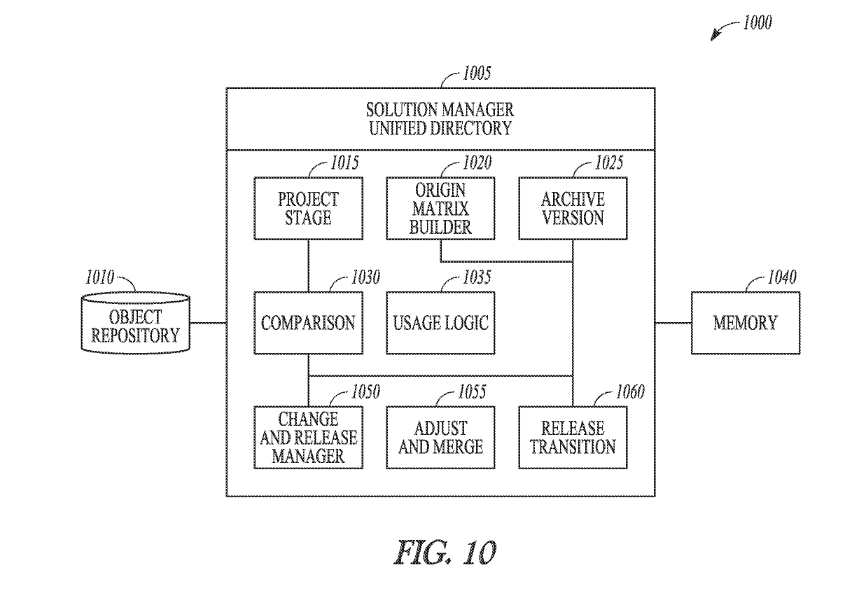

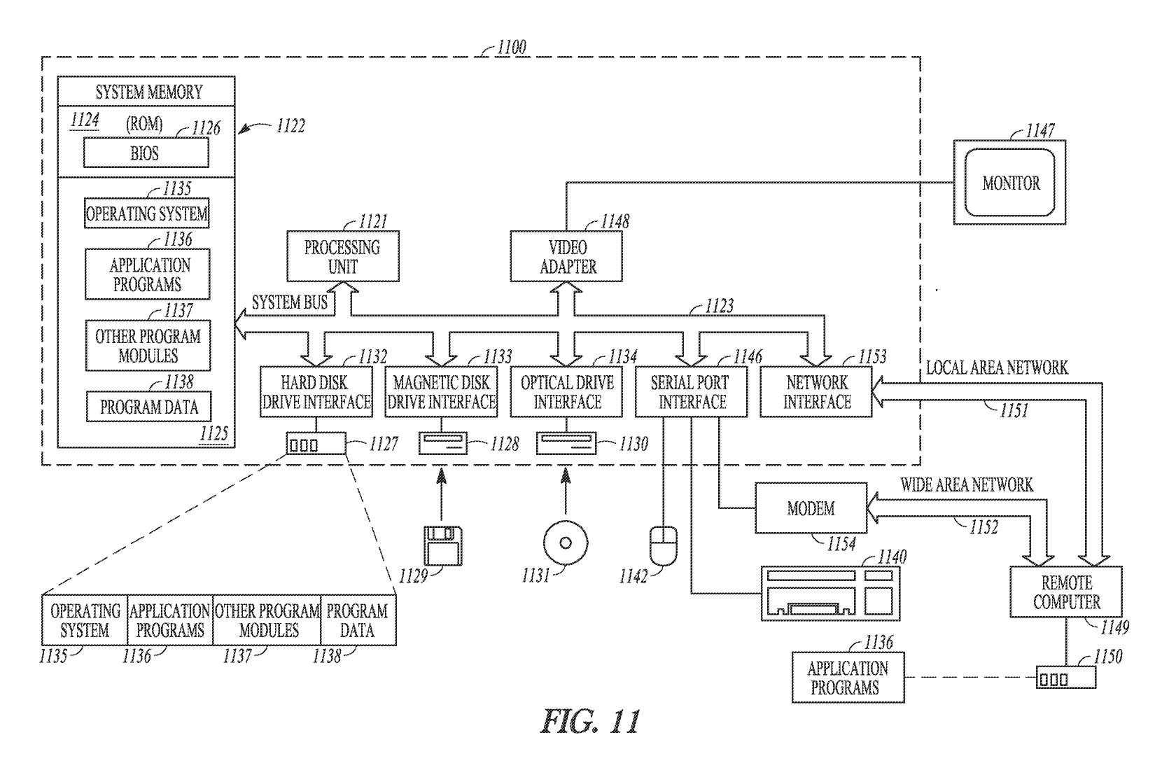

FIG. 10 is a block diagram of a system 1000 for maintaining the content of objects for multiple versions of the objects, applying the content from one version in a lifecycle stage to create another version of the objects. System 1000 has an object repository 1010 and a memory 1040. The object repository 1010 is a central repository for all objects that may be initially used to build modules. The object repository 1010 provides objects supplied by the manufacturer of the enterprise software system. New objects may be created in any or all lifecycle stages. The project stage module 1015 manages lifecycle stages.

Objects are initially supplied in the object repository 1010. Objects are copied from the object repository 1010 to an initial project stage. The archive version manager 1025 saves an archive of each object in the memory 1040. The origin matrix builder module 1020 creates an origin matrix for each object. The origin matrix lists information about the previous lifecycle stage (or stages if more than one previous stage exists) of the object and the predecessor data of the object. That is, the origin matrix has a column for each lifecycle stage and each column lists an object ID and an ID of the object archive. Every time an object is copied from one lifecycle stage to another lifecycle stage (i.e., a source object is copied to a further lifecycle stage, thus becoming a target object), the origin matrix builder module 1020 copies the origin matrix of the source object, associates it with the target object, and overwrites the data in the origin matrix so that it may be retrieved and used at a later time. Over time, the content of objects changes to reflect changes to the enterprise software system. For example, over time, the requirements for a marketing module might change because the company which is the user of the enterprise software system decides to do marketing campaigns differently. Thus, the content of each of the objects that build up the marketing module may be changed to reflect the new requirements so that the marketing module may provide the newly required functionality. With time, many such changes may be performed in one or all of the lifecycle stages of the enterprise software system. Also with time, there may be a need for one version of the content of an object to be applied to another version of the content of an object; that is, the content of an object from one lifecycle stage may need to be applied to the content of the object in a different lifecycle stage. Further, as content in each lifecycle stage changes with time, there may be a need to compare and apply the content of an archive of the time of creation of the object in the lifecycle stage to the current content of the object in a selected lifecycle stage. That is why, it may be necessary to create origin matrices at each lifecycle stage so that all versions of the content of an object from all lifecycle stages may be tracked and retrieved. The usage logic module 1035 retrieves usages of objects from lifecycle stages. If the content of an object in one lifecycle stage needs to be compared to the content of the object in another lifecycle stage, the usage logic module retrieves the usages and sends them to the comparison module. The comparison module 1030 compares the content of objects (such as current content and archived content) and, if necessary, applies the content of one version of the object to another version of the project.

A change and release manager 1050 is used to manage major changes to a system landscape. An adjust and merge function is indicated at 1055, and provides functions to manage parallel changes in release versions. The changes may be managed in a manner similar to changes occurring in different lifecycle versions utilizing a special version matrix called “release version matrix” with release predecessor and archive data by integrating and re-using the origin matrix builder 1020 with the change and release manager 1050. Release transition functionality 1060 provides a transition from a current release version to an updated release version using the comparison module 1030 and the adjust and merge function 1055 so that the new version may be used.

As shown in FIG. 11, one embodiment of the hardware and operating environment includes a general purpose computing device in the form of a computer 1100 (e.g., a personal computer, workstation, or server), including one or more processing units 1121, a system memory 1122, and a system bus 1123 that operatively couples various system components including the system memory 1122 to the processing unit 1121. There may be only one or there may be more than one processing unit 1121, such that the processor of computer 1100 comprises a single central-processing unit (CPU), or a plurality of processing units, commonly referred to as a multiprocessor or parallel-processor environment. In various embodiments, computer 1100 is a conventional computer, a distributed computer, or any other type of computer that is specifically programmed to perform the version release management functions described in the present application.

The system bus 1123 can be any of several types of bus structures including a memory bus or memory controller, a peripheral bus, and a local bus using any of a variety of bus architectures. The system memory can also be referred to as simply the memory, and, in some embodiments, includes read-only memory (ROM) 1124 and random-access memory (RAM) 1125. A basic input/output system (BIOS) program 1126, containing the basic routines that help to transfer information between elements within the computer 1100, such as during start-up, may be stored in ROM 1124. The computer 1100 further includes a hard disk drive 1127 for reading from and writing to a hard disk, not shown, a magnetic disk drive 1128 for reading from or writing to a removable magnetic disk 1129, and an optical disk drive 1130 for reading from or writing to a removable optical disk 1131 such as a CD ROM or other optical media.

The hard disk drive 1127, magnetic disk drive 1128, and optical disk drive 1130 couple with a hard disk drive interface 1132, a magnetic disk drive interface 1133, and an optical disk drive interface 1134, respectively. The drives and their associated computer-readable media provide non volatile storage of computer-readable instructions, data structures, program modules and other data for the computer 1100. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 1129, optical disk 1131, ROM 1124, or RAM 1125, including an operating system 1135, one or more application programs 1136, other program modules 1137, and program data 1138. Programming for implementing one or more process or method described herein may be resident on any one or number of these computer-readable media.

A user may enter commands and information into computer 1100 through input devices such as a keyboard 1140 and pointing device 1142. Other input devices (not shown) can include a microphone, joystick, game pad, satellite dish, scanner, or the like. These other input devices are often connected to the processing unit 1121 through a serial port interface 1146 that is coupled to the system bus 1123, but can be connected by other interfaces, such as a parallel port, game port, or a universal serial bus (USB). A monitor 1147 or other type of display device can also be connected to the system bus 1123 via an interface, such as a video adapter 1148. The monitor 1147 can display a graphical user interface for the user. In addition to the monitor 1147, computers typically include other peripheral output devices (not shown), each as speakers and printers.

The computer 1100 may operate in a networked environment using logical connections to one or more remote computers or servers, such as remote computer 1149. These logical connections are achieved by a communication device coupled to or a part of the computer 1100; the invention is not limited to a particular type of communications device. The remote computer 1149 can be another computer, a server, a router, a network PC, a client, a peer device or other common network node, and typically includes many or all of the elements described above I/O relative to the computer 1100, although only a memory storage device 1150 has been illustrated. The logical connections depicted in FIG. 11 includes a local area network (LAN) 1151 and/or a wide area network (WAN) 1152. Such networking environments are commonplace in office networks, enterprise-wide computer networks, intranets and the internet, which are all types of networks.

When used in a LAN-networking environment, the computer 1100 is connected to the LAN 1151 through a network interface or adapter 1153, which is one type of communications device. In some embodiments, when used in a WAN-networking environment, the computer 1100 typically includes a modem 1154 (another type of communications device) or any other type of communications device, e.g., a wireless transceiver, for establishing communications over the wide-area network 1152, such as the internet. The modem 1154, which may be internal or external, is connected to the system bus 1123 via the serial port interface 1146. In a networked environment, program modules depicted relative to the computer 1100 can be stored in the remote memory storage device 1150 of remote computer, or server 1149. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

1. A method for providing releases, the method comprising:
   obtaining an existing process structure for multiple life cycle stages of a process lifecycle instance via a release provider executing on a computer;
   using a release version matrix to represent the process structures via the release provider;
   receiving a release change indication;
   copying the existing process structures into new release process structures to represent a new version of the process in response to the release change via the release provider; and
   updating the release version matrix to identify the new version of the process structures for a release consumer via the release provider.
2. The method of example 1 wherein the release version matrix includes identification of a predecessor process and an archive process for the new version of the process structures.
3. The method of any one of examples 1-2 wherein a release change indication is provided by a release sequence to be applied to the process lifecycle instance via a release consumer.
4. The method of any one of examples 1-3 wherein the release sequence identifies a new release, and a predecessor release, and wherein the release consumer manages the consumption of a new release from a release provider based on the release sequence.
5. The method of any one of examples 1-4 wherein the release sequence identifies multiple logical components of the new release and the predecessor release, and wherein one of the logical components comprises a new version of the logical component.
6. The method of any one of examples 1-5 and further comprising:
   identifying a document occurrence object associated with the existing process for multiple lifecycle stages;
   obtaining a link for each document occurrence object to a proxy object; and
   creating a document version matrix for the document occurrences.
7. The method of any one of examples 1-6 wherein a same document version is linked for general documentation and where the document is linked to several processes.
8. The method of any one of examples 1-6 wherein a change to a document that is associated with a proxy object used by several documents occurrences results in the creation of a new proxy object associated with the changed document.
9. The method of any one of examples 1-6 wherein the document version matrix is capable of identifying different document versions for different life cycle stages.
10. A computing system comprising:
   an object repository to maintain a set of objects;
   a project stage module to maintain an object in each of a set of project stages;
   a matrix builder module to build a release version matrix for the object when the object transitions from a source object in a first release to a target object in a second release, wherein the release version matrix includes a first column to represent the first release, a second column to represent the second release, and a row to represent a predecessor object; and
   a memory to store the release version matrix of the object.
11. The system of any one of examples 1-10 and further comprising a change and release manager to control changing versions of objects.
12. The system of any one of examples 1-11 and further comprising an adjust and merge function to create the second release by adjusting the first release and merging information from the first release into the second release.
13. The system of any one of examples 1-12 and further comprising a release transition function to transition from a current release version to an updated release version.
14. The system of any one of examples 1-13 wherein the release version matrix includes identification of a predecessor process and an archive process for the new version of the process structures.
15. The system of any one of examples 1-14 wherein a release change indication is provided by a release sequence to be applied to current release version.
16. The system of any one of examples 1-15 wherein the release sequence identifies a second release, the first release, and multiple logical components of the second release and the first release, and wherein one of the logical components comprises a new version of the logical component.
17. A computer readable storage device having instructions for causing a computer to execute a method, the method comprising:
   obtaining an existing process structure for multiple life cycle stages of a process lifecycle instance;
   using a release version matrix to represent the process structures;
   receiving a release change indication;
   copying the existing process structures into new release process structures to represent a new version of the process in response to the release change; and
   updating the release version matrix to identify the new version of the process structures.
18. The computer readable storage device of any one of examples 1-17 wherein the release version matrix includes identification of a predecessor process and an archive process for the new version of the process structures.
19. The computer readable storage device of any one of examples 1-18 wherein a release change indication is provided by a release sequence to be applied to the process lifecycle instance, wherein the release sequence identifies a new release, a predecessor release, multiple logical components of the new release and the predecessor release, and wherein one of the logical components comprises a new version of the logical component.
20. The computer readable storage device of any one of examples 1-19 and wherein the method further comprises:
   identifying a document occurrence object associated with the existing process for multiple lifecycle stages;
   obtaining a link for each document occurrence object to a proxy object; and
   creating a document version matrix for the document occurrences, wherein a same document version is linked for general documentation and where the document is linked to several processes, wherein a change to a document that is associated with a proxy object used by several documents occurrences results in the creation of a new proxy object associated with the changed document, and wherein the document version matrix is capable of identifying different version documents for different life cycle stages.
21. A method of consuming releases by a release consumer, the method comprising:
   obtaining a version matrix at a release consumer executing on a processor, the version matrix identifying a new version of process structures from a release provider, wherein the release version matrix includes identification of a predecessor process and an archive process for the new version of the process structures;
   applying a release change indication to a process lifecycle instance via the release consumer; and
   managing the consumption of a new release via the release consumer based on a release sequence that identifies a new release, and a predecessor release.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method for providing releases, the method comprising:
obtaining an existing process structure for multiple life cycle stages of a process lifecycle instance via a release provider executing on a computer;
using a release version matrix to represent the process structures via the release provider;
receiving a release change indication;
copying the existing process structures into new release process structures to represent a new version of the process in response to the release change via the release provider; and
updating the release version matrix to identify the new version of the process structures for a release consumer via the release provider.

2. The method of claim 1 wherein the release version matrix includes identification of a predecessor process and an archive process for the new version of the process structures.

3. The method of claim 1 wherein a release change indication is provided by a release sequence to be applied to the process lifecycle instance via a release consumer.

4. The method of claim 3 wherein the release sequence identifies a new release, and a predecessor release, and wherein the release consumer manages the consumption of a new release from a release provider based on the release sequence.

5. The method of claim 4 wherein the release sequence identifies multiple logical components of the new release and the predecessor release, and wherein one of the logical components comprises a new version or the logical component.

6. The method of claim 1 and further comprising:
identifying a document occurrence object associated with the existing process for multiple lifecycle stages;
obtaining a link for each document occurrence object to a proxy object; and
creating a document version matrix for the document occurrences.

7. The method of claim 6 wherein a same document version is linked for general documentation and where the document is linked to several processes.

8. The method of claim 6 wherein a change to a document that is associated with a proxy object used by several documents occurrences results in the creation of a new proxy object associated with the changed document.

9. The method of claim 6 wherein the document version matrix is capable of identifying different document versions for different life cycle stages.

10. A computing system comprising:
an object repository to maintain a set of objects;
a project stage module to maintain an object in each of a set of project stages;
a matrix builder module to build a release version matrix for the object when the object transitions from a source object in a first release to a target object in a second release, wherein the release version matrix includes a first column to represent the first release, a second column to represent the second release, and a row to represent a predecessor object; and
a memory to store the release version matrix of the object.

11. The system of claim 10 and further comprising a change and release manager to control changing versions of objects.

12. The system of claim 11 and further comprising an adjust and merge function to create the second release by adjusting the first release and merging information from the first release into the second release.

13. The system of claim 12 and further comprising a release transition function to transition from a current release version to an updated release version.

14. The system of claim 10 wherein the release version matrix includes identification of a predecessor process and an archive process for the new version of the process structures.

15. The system of claim 10 wherein a release change indication is provided by a release sequence to be applied to current release version.

16. The system of claim 15 wherein the release sequence identifies a second release, the first release, and multiple logical components of the second release and the first release, and wherein one of the logical components comprises a new version of the logical component.

17. A computer readable storage device having instructions for causing a computer to execute a method, the method comprising:
obtaining an existing process structure for multiple life cycle stages of a process lifecycle instance;
using a release version matrix to represent the process structures;
receiving a release change indication;
copying the existing process structures into new release process structures to represent a new version of the process in response to the release change; and
updating the release version matrix to identify the new version of the process structures.

18. The computer readable storage device of claim 17 wherein the release version matrix includes identification of a predecessor process and an archive process for the new version of the process structures.

19. The computer readable storage device of claim 17 wherein a release change indication is provided by a release sequence to be applied to the process lifecycle instance, wherein the release sequence identifies a new release, a predecessor release, multiple logical components of the new release and the predecessor release, and wherein one of the logical components comprises a new version of the logical component.

20. The computer readable storage device of claim 17 and wherein the method further comprises:
identifying a document occurrence object associated with the existing process for multiple lifecycle stages;
obtaining a link for each document occurrence object to a proxy object; and
creating a document version matrix for the document occurrences, wherein a same document version is linked for general documentation and where the document is linked to several processes, wherein a change to a document that is associated with a proxy object used by several documents occurrences results in the creation of a new proxy object associated with the changed document, and wherein the document version matrix is capable of identifying different version documents for different life cycle stages.

21. A method of consuming releases by a release consumer, the method comprising:
obtaining a version matrix at a release consumer executing on a processor, the version matrix identifying a new version of process structures from a release provider, wherein the release version matrix includes identification of a predecessor process and an archive process for the new version of the process structures;
applying a release change indication to a process lifecycle instance via the release consumer; and
managing the consumption of a new release via the release consumer based on a release sequence that identifies a new release, and a predecessor release.
